(19) United States
(12) Patent Application Publication
(10) Pub. No.: US 2026/0118674 A1
(43) Pub. Date: Apr. 30, 2026

(54) EXTERNAL CHARGING MODULE AND NEAR EYE DISPLAY DEVICE

(71) Applicant: APACECORE PTE. LTD., Hsinchu County (TW)

(72) Inventor: Bo-Jhang Sun, Hsinchu County (TW)

(73) Assignee: APACECORE PTE. LTD., Hsinchu County (TW)

(21) Appl. No.: 18/974,597

(22) Filed: Dec. 9, 2024

(30) Foreign Application Priority Data
Oct. 29, 2024 (TW) 113141252

(51) Int. Cl. G02B 27/01; G02F 1/157

(52) U.S. Cl. CPC G02B 27/0172; G02B 27/0176; G02F 1/157; G02B 2027/0178; G02F 2201/465; G02F 2203/01

(57) ABSTRACT

An external charging module, detachably configured on a wearable display module, is provided. The external charging module has an optical axis. The external charging module includes a light transmitting power generation element, a dimming element, and a connection element. The light transmitting power generation element is configured to receive a light energy to generate an electric energy. The dimming element is configured on the light transmitting power generation element. The dimming element is configured to adjust light transmittance. The connection element is electrically connected to the light transmitting power generation element. When the external charging module is configured on the wearable display module, the connection element is connected to a rim of the wearable display module, so that the light transmitting power generation element charges an electric energy element of the wearable display module. In addition, a near eye display device is also provided.

### CROSS-REFERENCE TO RELATED APPLICATION

This application claims the priority benefit of Taiwan application serial no. 113141252, filed on Oct. 29, 2024. The entirety of the above-mentioned patent application is hereby incorporated by reference herein and made a part of this specification.

### BACKGROUND

### Technical Field

The disclosure relates to an external module and a display device, and in particular to an external charging module and a near eye display device.

### Description of Related Art

Near eye display (NED) and head-mounted display (HMD) are next-generation killer products with great development potential. Related applications of near eye display technology may be currently divided into augmented reality (AR) technology and virtual reality (VR) technology. The augmented reality technology is a technology that spatially visualizes various information in the real world. Users are provided with virtual information through contents such as images, videos, and 3D models, enhancing perception and interactive behavior of the users with the real physical world. The near eye display device is the core part of implementing the augmented reality technology. Such type of near eye display device is usually characterized by an optical combiner (for example, a beam splitter, a partial reflector, a prism, or a waveguide lens) placed in front of the eyes of the user to guide an image projection beam from the display and external ambient light to enter the eyes of the user. Therefore, the user may simultaneously observe virtual information generated by the image beam and the physical world formed by the external ambient light.

However, in the near eye display or the head-mounted display applying the augmented reality technology, as the display quality improves year by year, the battery life of the device has become an important indicator that cannot be ignored. Therefore, how to develop a near eye display device with good battery life and practicality for use by the user is one of the goals in the art.

### SUMMARY

The disclosure provides an external charging module and a near eye display device. A user may selectively wear the external charging module to a wearable display module according to different situations to adjust light transmittance and charge the wearable display module, so as to improve the practicality of the near eye display device.

The disclosure provides an external charging module detachably configured on a wearable display module. The external charging module has an optical axis. The external charging module includes a light transmitting power generation element, a dimming element, and a connection element. The light transmitting power generation element is configured to receive a light energy to generate an electric energy. The dimming element is configured on the light transmitting power generation element. The dimming element is configured to adjust light transmittance. The connection element is electrically connected to the light transmitting power generation element. When the external charging module is configured on the wearable display module, the connection element is connected to a rim of the wearable display module, so that the light transmitting power generation element charges an electric energy element of the wearable display module.

In an embodiment of the disclosure, the connection element includes a magnetic material, and when the external charging module is configured on the wearable display module, the connection element is magnetically connected to the rim.

In an embodiment of the disclosure, in a direction of the optical axis, the light transmitting power generation element and the dimming element completely overlap.

In an embodiment of the disclosure, when the external charging module is configured on the rim, the light transmitting power generation element is located between the rim and the dimming element.

In an embodiment of the disclosure, when the external charging module is configured on the rim, the dimming element is located between the rim and the light transmitting power generation element.

In an embodiment of the disclosure, the external charging module further includes an external frame including a light passing area. The light transmitting power generation element and the dimming element are configured in the light passing area of the external frame.

In an embodiment of the disclosure, the connection element is configured on the external frame, and the connection element and the light passing area of the external frame do not overlap in a direction of the optical axis.

The disclosure also provides a near eye display device including a wearable display module and an external charging module. The wearable display module is configured to provide an imaging beam to a user and allow an ambient beam to pass through to be transmitted to the user. The wearable display module includes a wearable frame, a display element, an imaging element, and an electric energy element. The wearable frame includes a rim and a temple connected to the rim. The rim includes a light passing area. The display element is configured on the temple. The display element is configured to provide an image beam. The imaging element is configured in the light passing area of the rim and is located on a transmission path of the image beam. The image beam is formed into an imaging beam on the imaging element. The electric energy element is electrically connected to the display element. The electric energy element is configured to provide an electric energy to the display element. The external charging module is detachably configured on the wearable display module. The external charging module has an optical axis. The external charging module includes a light transmitting power generation element, a dimming element, and a connection element. The light transmitting power generation element is configured to receive a light energy to generate the electric energy. The dimming element is configured on the light transmitting power generation element. The dimming element is configured to adjust light transmittance. The connection element is electrically connected to the light transmitting power generation element. When the external charging module is configured on the wearable display module, the connection element is connected to a rim of the wearable display module, so that the light transmitting power generation element charges the electric energy element of the wearable display module.

In an embodiment of the disclosure, the connection element includes a magnetic material, and when the external charging module is configured on the wearable display module, the connection element is magnetically connected to the rim.

In an embodiment of the disclosure, in a direction of the optical axis, the light transmitting power generation element and the dimming element completely overlap.

In an embodiment of the disclosure, in a direction of the optical axis, the light transmitting power generation element and the imaging element completely overlap.

In an embodiment of the disclosure, in a direction of the optical axis, the dimming element and the imaging element completely overlap.

In an embodiment of the disclosure, when the external charging module is configured on the rim, the light transmitting power generation element is located between the rim and the dimming element.

In an embodiment of the disclosure, when the external charging module is configured on the rim, the dimming element is located between the rim and the light transmitting power generation element.

In an embodiment of the disclosure, the external charging module further includes an external frame. The external frame includes a light passing area. The light transmitting power generation element and the dimming element are configured in the light passing area of the external frame.

In an embodiment of the disclosure, the connection element is configured on the external frame, and the connection element and the light passing area of the external frame do not overlap in a direction of the optical axis.

Based on the above, in the external charging module and the near eye display device of the disclosure, the near eye display device includes the wearable display module and the external charging module. The wearable display module includes the wearable frame, the display element, the imaging element, and the electric energy element. The external charging module includes the light transmitting power generation element, the dimming element, and the connection element. The wearable display module is configured to provide the imaging beam to the user and allow the ambient beam to pass through to be transmitted to the user, and the external charging module is detachably configured on the wearable display module. When the external charging module is configured on the wearable display module, the dimming element is configured to adjust the light transmittance, and the connection element is connected to the wearable frame, so that the light transmitting power generation element charges the electric energy element. In this way, the user may selectively wear the external charging module to the wearable display module according to different situations to adjust the light transmittance and charge the wearable display module, so as to improve the practicality of the near eye display device.

In order for the features and advantages of the disclosure to be more comprehensible, the following specific embodiments are described in detail in conjunction with the drawings.

### BRIEF DESCRIPTION OF THE DRAWINGS

FIG. 1A and FIG. 1B are respectively schematic views of separation and combination of an external charging module and a wearable display module of a near eye display device according to an embodiment of the disclosure.

FIG. 2 is a schematic side view of the near eye display device of FIG. 1B.

FIG. 3 is a schematic side view of a near eye display device according to an embodiment of the disclosure.

FIG. 4 is a schematic side view of a near eye display device according to an embodiment of the disclosure.

FIG. 5 is a schematic side view of a near eye display device according to an embodiment of the disclosure.

### DESCRIPTION OF THE EMBODIMENTS

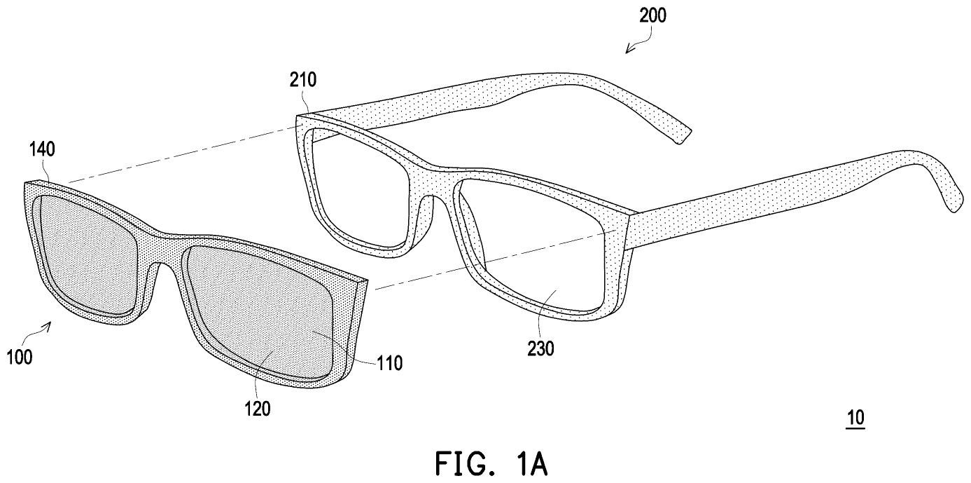

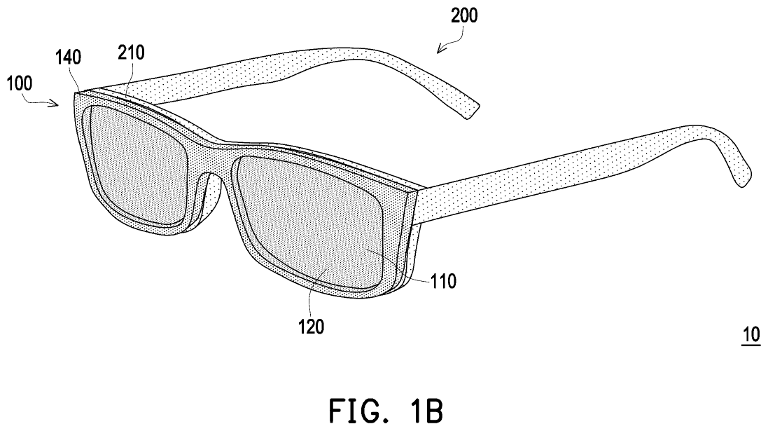

FIG. 1A and FIG. 1B are respectively schematic views of separation and combination of an external charging module and a wearable display module of a near eye display device according to an embodiment of the disclosure. Please refer to FIG. 1A and FIG. 1B. The embodiment provides a near eye display device 10, such as a wearable display with a spectacle appearance. The near eye display device 10 includes a wearable display module 200 and an external charging module 100. The wearable display module 200 is configured to provide an imaging beam L2 to a user and allow an ambient beam L3 to pass through to be transmitted to the user, so that the user may observe a virtual image when wearing the near eye display device 10, and augmented reality (AR) is implemented in conjunction with an ambient real object. The external charging module 100 is detachably configured on the wearable display module 200, such as the different states shown in FIG. 1A and FIG. 1B. The user may selectively configure the external charging module 100 according to different situations. When the user configures the external charging module 100 on the wearable display module 200, the appearance is presented as shown in FIG. 1B, and the external charging module 100 is configured to charge the wearable display module 200 and provide additional optical effects (such as shading).

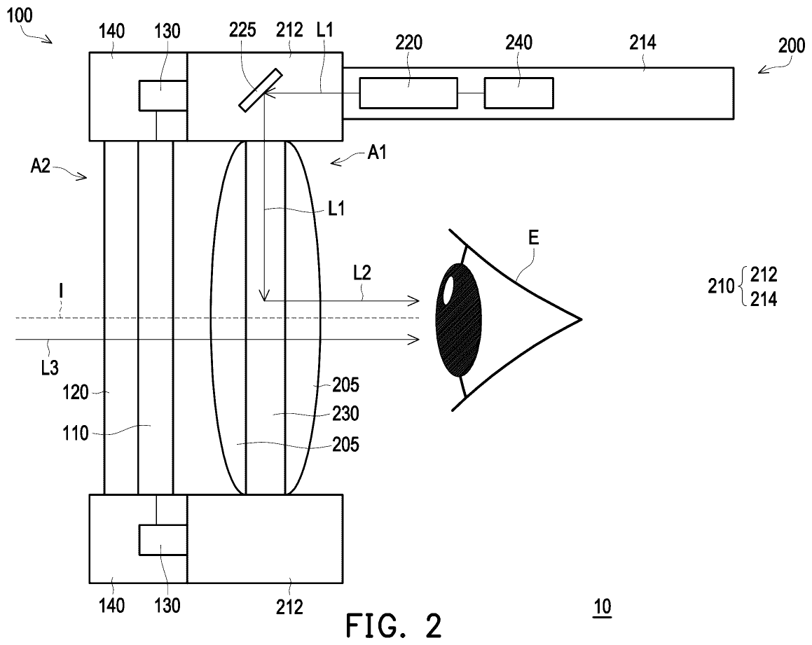

FIG. 2 is a schematic side view of the near eye display device of FIG. 1B. Please refer to FIG. 1A to FIG. 2 at the same time. In the embodiment, the wearable display module 200 includes a wearable frame 210, a display element 220, an imaging element 230, and an electric energy element 240. The wearable frame 210 includes a rim 212 and a temple 214 connected to the rim 212. The rim 212 includes a light passing area A1. When the user wears the near eye display device 10, the position of the light passing area A1 corresponds to an eye E of the user. The wearable frame 210 is, for example, a spectacle frame.

The display element 220 is configured on the temple 214 of the wearable frame 210. The display element 220 is configured to provide an image beam L1. The display element 220 includes, for example, a light emitting element (for example, a light emitting diode, a laser diode, or other types of light emitting elements) for providing the image beam L1, an image generating element (for example, a light valve or a display panel), and a lens element, but the disclosure does not limit the type and the structure of the display element 220.

The imaging element 230 is configured in the light passing area A1 of the rim 212 and is located on a transmission path of the image beam L1. The image beam L1 is formed into the imaging beam L2 on the imaging element 230. For example, in the embodiment, the image beam L1 provided by the display element 220 may be transmitted to the imaging element 230 by a transmission element 225 (for example, a reflector), but the disclosure is not limited thereto. The imaging element 230 is, for example, a waveguide and is configured to convert the image beam L1 into the imaging beam L2, and then reflect and transmit the imaging beam L2 to the eye E of the user. The disclosure does not limit the type of the imaging element 230. In the embodiment, additional protective elements 205, such as protective glass, may be configured on two sides of the imaging element 230, but the disclosure does not limit the appearance, the number, and the type of the protective elements 205.

The electric energy element 240 is configured on the temple 214 of the wearable frame 210 and is electrically connected to the display element 220. The electric energy element 240 is, for example, a lithium battery and is configured to provide an electric energy to the display element 220.

The external charging module 100 has an optical axis I. In the embodiment, the external charging module 100 includes a light transmitting power generation element 110, a dimming element 120, and a connection element 130. The light transmitting power generation element 110 is, for example, a transmissive or semi-transmissive perovskite solar cell (PSC) and is configured to receive a light energy to generate the electric energy. In the embodiment, in the direction of the optical axis I, the light transmitting power generation element 110 and the imaging element 230 may be designed to completely overlap.

The dimming element 120 is configured on the light transmitting power generation element 110, and the dimming element 120 is configured to adjust light transmittance. For example, the dimming element 120 is a photochromic lens or an electrochromic lens. The photochromic lens is, for example, a substance in a lens that changes the light transmittance of the lens in response to the intensity of light irradiating the lens, and the electrochromic lens, for example, changes the light transmittance of the lens in response to the voltage applied to electrodes of the lens, but the disclosure is not limited thereto. In this way, the light intensity of the external ambient light may be further adjusted to improve the optical quality of the near eye display device 10. In the embodiment, in the direction of the optical axis I, the dimming element 120 and the imaging element 230 may be designed to completely overlap. In addition, in the embodiment, in the direction of the optical axis I, the light transmitting power generation element 110 and the dimming element 120 may also be designed to completely overlap. In the embodiment, when the external charging module 100 is configured on the rim 212 of the wearable frame 210, the light transmitting power generation element 110 is located between the rim 212 and the dimming element 120.

The connection element 130 is electrically connected to the light transmitting power generation element 120. When the external charging module 100 is configured on the wearable display module 200, the connection element 130 is connected to the wearable frame 210, so that the light transmitting power generation element 110 charges the electric energy element 240. For example, in the embodiment, the connection element 130 includes a magnetic material and is configured to magnetically connect to the rim 212 of the wearable frame 210. In this way, the user may selectively wear the external charging module 100 to the wearable display module 200 according to different situations to adjust the light transmittance and charge the wearable display module 200, so as to improve the practicality of the near eye display device 10. In different embodiment designs, the light transmitting power generation element 120 may also be designed to directly supply power to the display element 220, but the disclosure is not limited thereto.

Specifically, in the embodiment, the external charging module 100 further includes an external frame 140. The external frame 140 includes a light passing area A2, and the light transmitting power generation element 110 and the dimming element 120 are configured in the light passing area A2 of the external frame 140. The appearance of the external frame 140 is, for example, the same as the appearance of the rim 212 of the wearable frame 210, but the disclosure is not limited thereto. The connection element 130 is configured on the external frame 140, and the connection element 130 does not overlap with the light passing area A2 of the external frame 140 in the direction of the optical axis I. In other words, the external frame 140 and the wearable frame 210 may be designed to be embedded with a circuit structure, so that the light transmitting power generation element 110 may transmit the provided electric energy to the electric energy element 240 for charging by the circuit structure.

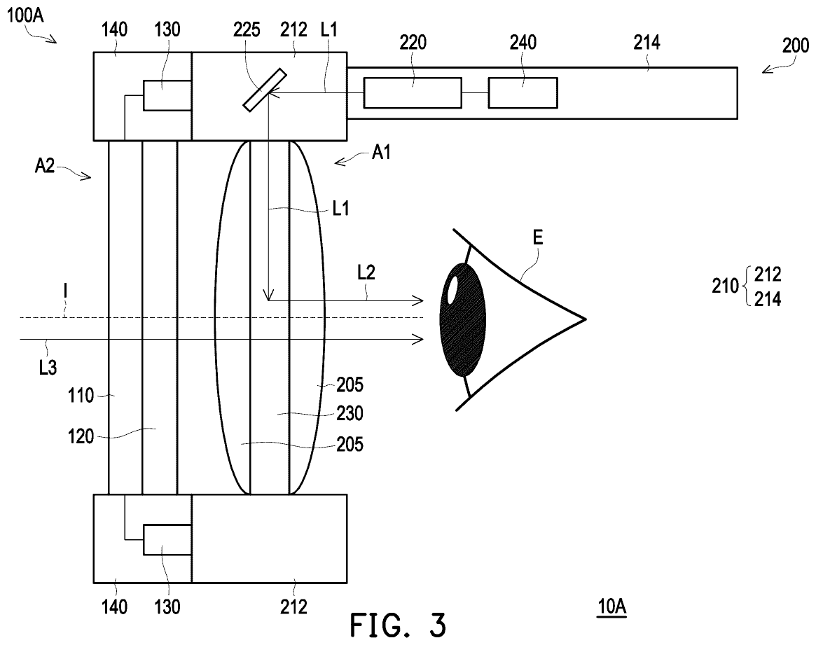

FIG. 3 is a schematic side view of a near eye display device according to an embodiment of the disclosure. Please refer to FIG. 3. A near eye display device 10A shown in the embodiment is similar to the near eye display device 10 shown in FIG. 2. The difference between the two is that in the embodiment, when an external charging module 100A is configured on the rim 212 of the wearable frame 210, the dimming element 120 is located between the rim 212 and the light transmitting power generation element 110. Therefore, the light transmitting power generation element 110 may be directly irradiated by the ambient beam L3 to improve the power generation efficiency, and the dimming element 120 is also closer to the imaging element 230, so the dimming accuracy of the external charging module 100A can be further improved.

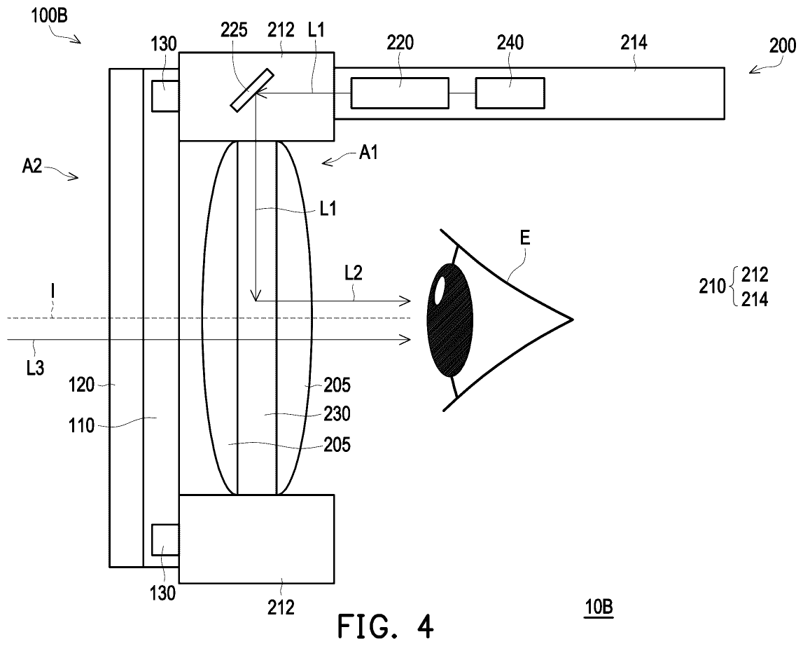

FIG. 4 is a schematic side view of a near eye display device according to an embodiment of the disclosure. A near eye display device 10B shown in the embodiment is similar to the near eye display device 10 shown in FIG. 2. The difference between the two is that in the embodiment, an external charging module 100B omits the external frame 140 shown in FIG. 2. In other words, in the embodiment, the connection element 130 is directly embedded in the light transmitting power generation element 110. Therefore, when the external charging module 100B is configured on the rim 212 of the wearable frame 210, the connection element 130 embedded in the light transmitting power generation element 110 is directly connected to the rim 212. In this way, the appearance diversity of the external charging module 100B may be increased.

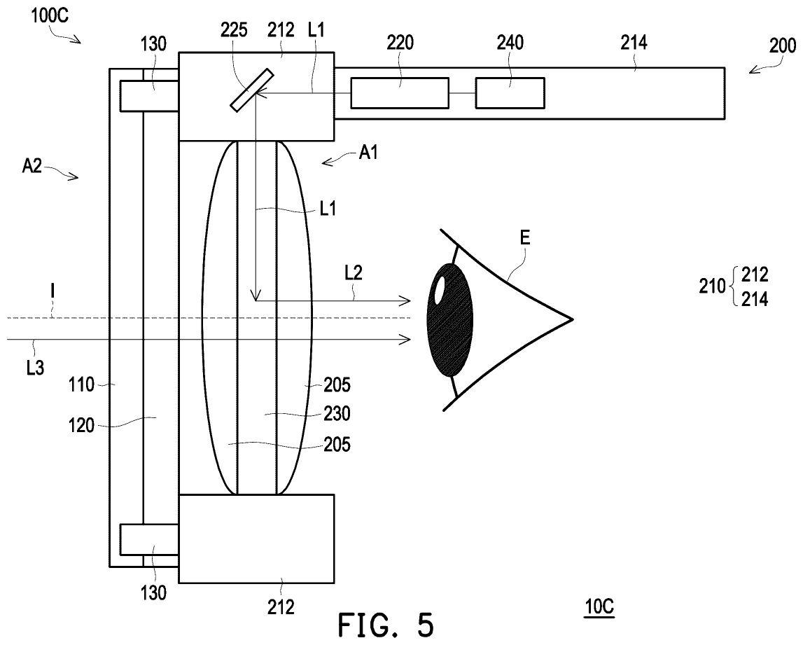

FIG. 5 is a schematic side view of a near eye display device according to an embodiment of the disclosure. A near eye display device 10C shown in the embodiment is similar to the near eye display device 10B shown in FIG. 4. The difference between the two is that in the embodiment, when an external charging module 100C is configured on the rim 212 of the wearable frame 210, the dimming element 120 is located between the rim 212 and the light transmitting power generation element 110. The connection element 130 is embedded in the light transmitting power generation element 110 and extends through the dimming element 120. Therefore, the light transmitting power generation element 110 may be directly irradiated by the ambient beam L3 to improve the power generation efficiency, and the dimming element 120 is also closer to the imaging element 230, so the dimming accuracy of the external charging module 100C can be further improved.

In summary, in the external charging module and the near eye display device of the disclosure, the near eye display device includes the wearable display module and the external charging module. The wearable display module includes the wearable frame, the display element, the imaging element, and the electric energy element. The external charging module includes the light transmitting power generation element, the dimming element, and the connection element. The wearable display module is configured to provide the imaging beam to the user and allow the ambient beam to pass through to be transmitted to the user, and the external charging module is detachably configured on the wearable display module. When the external charging module is configured on the wearable display module, the dimming element is configured to adjust the light transmittance, and the connection element is connected to the wearable frame, so that the light transmitting power generation element charges the electric energy element. In this way, the user may selectively wear the external charging module to the wearable display module according to different situations to adjust the light transmittance and charge the wearable display module, so as to improve the practicality of the near eye display device.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An external charging module, detachably configured on a wearable display module, wherein the external charging module has an optical axis, the external charging module comprising:
a light transmitting power generation element, configured to receive a light energy to generate an electric energy;
a dimming element, configured on the light transmitting power generation element, wherein the dimming element is configured to adjust light transmittance; and
a connection element, electrically connected to the light transmitting power generation element, wherein when the external charging module is configured on the wearable display module, the connection element is connected to a rim of the wearable display module, so that the light transmitting power generation element charges an electric energy element of the wearable display module.

2. The external charging module according to claim 1, wherein the connection element comprises a magnetic material, and when the external charging module is configured on the wearable display module, the connection element is magnetically connected to the rim.

3. The external charging module according to claim 1, wherein in a direction of the optical axis, the light transmitting power generation element and the dimming element completely overlap.

4. The external charging module according to claim 1, wherein when the external charging module is configured on the rim, the light transmitting power generation element is located between the rim and the dimming element.

5. The external charging module according to claim 1, wherein when the external charging module is configured on the rim, the dimming element is located between the rim and the light transmitting power generation element.

6. The external charging module according to claim 1, further comprising:
an external frame, comprising a light passing area, wherein the light transmitting power generation element and the dimming element are configured in the light passing area of the external frame.

7. The external charging module according to claim 6, wherein the connection element is configured on the external frame, and the connection element and the light passing area of the external frame do not overlap in a direction of the optical axis.

8. A near eye display device, comprising:
a wearable display module, configured to provide an imaging beam to a user and allow an ambient beam to pass through to be transmitted to the user, wherein the wearable display module comprises:
a wearable frame, comprising a rim and a temple connected to the rim, wherein the rim comprises a light passing area;
a display element, configured on the temple, wherein the display element is configured to provide an image beam;
an imaging element, configured in the light passing area of the rim and located on a transmission path of the image beam, wherein the image beam is formed into the imaging beam on the imaging element; and
an electric energy element, electrically connected to the display element, wherein the electric energy element is configured to provide an electric energy to the display element; and
an external charging module, detachably configured on the wearable display module, wherein the external charging module has an optical axis, and the external charging module comprises:
a light transmitting power generation element, configured to receive a light energy to generate the electric energy;
a dimming element, configured on the light transmitting power generation element, wherein the dimming element is configured to adjust light transmittance; and
a connection element, electrically connected to the light transmitting power generation element, wherein when the external charging module is configured on the wearable display module, the connection element is connected to the wearable frame, so that the light transmitting power generation element charges the electric energy element.

9. The near eye display device according to claim 8, wherein the connection element comprises a magnetic material, and when the external charging module is configured on the wearable display module, the connection element is magnetically connected to the rim.

10. The near eye display device according to claim 8, wherein in a direction of the optical axis, the light transmitting power generation element and the dimming element completely overlap.

11. The near eye display device according to claim 8, wherein in a direction of the optical axis, the light transmitting power generation element and the imaging element completely overlap.

12. The near eye display device according to claim 8, wherein in a direction of the optical axis, the dimming element and the imaging element completely overlap.

13. The near eye display device according to claim 8, wherein when the external charging module is configured on the rim, the light transmitting power generation element is located between the rim and the dimming element.

14. The near eye display device according to claim 8, wherein when the external charging module is configured on the rim, the dimming element is located between the rim and the light transmitting power generation element.

15. The near eye display device according to claim 8, wherein the external charging module further comprises an external frame, the external frame comprises a light passing area, and the light transmitting power generation element and the dimming element are configured in the light passing area of the external frame.

16. The near eye display device according to claim 15, wherein the connection element is configured on the external frame, and the connection element and the light passing area of the external frame do not overlap in a direction of the optical axis.
